(19) United States
(12) Patent Application Publication
(10) Pub. No.: US 2025/0008526 A1
(43) Pub. Date: Jan. 2, 2025

(54) METHODS ON ENHANCING RELIABILITY AND SUPPORTING MIXED PRIORITY TRAFFIC IN HIGH FREQUENCY COMMUNICATIONS

(71) Applicant: INTERDIGITAL PATENT HOLDINGS, INC., Wilmington, DE (US)

(72) Inventors: Prasanna Herath, Laval (CA); Young Woo Kwak, Woodbury, NY (US); Moon IL Lee, Melville, NY (US); Paul Marinier, Brossard (CA); Nazli Khan Beigi, Longueuil (CA)

(73) Assignee: INTERDIGITAL PATENT HOLDINGS, INC., Wilmington, DE (US)

(21) Appl. No.: 18/708,844

(22) PCT Filed: Nov. 10, 2022
(86) PCT No.: PCT/US2022/049501

§ 371 Date: May 9, 2024

Related U.S. Application Data
(60) Provisional application No. 63/277,895, filed on Nov. 10, 2021.

(51) Int. Cl. H04W 72/232; H04L 5/00; H04W 72/563

(52) U.S. Cl. CPC H04W 72/232; H04L 5/0094; H04W 72/563

(57) ABSTRACT

A method performed by a wireless transmit/receive unit (WTRU) may compromise: receiving a downlink control information, wherein the DCI includes a multi-PDSCH priority indication; determining a priority for each of a two or more PDSCHs transmissions based on the multi-PDSCH priority indication; determining one or more scheduling parameters for each of the two or more PDSCH transmissions based on the determined priority of each of the two or more PDSCH transmissions; and receiving each of the two or more PDSCH transmissions using the respective determined scheduling parameters. The method may further compromise associating a first scheduling parameter with a first priority and a second scheduling parameter with a second priority, wherein the first priority is a high priority and the second priority is a low priority.

### CROSS-REFERENCE TO RELATED APPLICATIONS

This application claims the benefit of U.S. Provisional Application No. 63/277,895, filed Nov. 10, 2021, the contents of which are incorporated herein by reference.

### BACKGROUND

Higher subcarrier spacing (SCS) is used for high frequencies communication, for example 480 kHz and 960 KHz are supported in Frequency Range 2-2 (FR2-2). These SCSs result in a short slot duration compared to lower SCSs supported for low carrier frequencies. To reduce the signaling overhead and take advantage of large channel coherent time relative to the slot duration, scheduling up to 8 physical downlink channel shared channels (PDSCHs) by a single DCI has been developed. All scheduled PDSCHs share the same priority index and modulation and coding scheme (MCS). With this configuration, priority of each PDSCH cannot be flexibly configured. Also, different priority traffic demand different reliability and latency requirements. Transmitting different replicas of the same PDSCH, for example, different resource blocks (RBs) using the same transmission/reception point (TRP) may provide some gains. However, multi-TRP communication are useful with these short slot duration communication as it may provide time and frequency domain diversity gains in addition to signal-to-noise ratio (SNR) gains.

### SUMMARY

A method performed by a wireless transmit/receive unit (WTRU) may compromise: receiving a downlink control information (DCI), wherein the DCI includes a multi-physical downlink channel shared channel (PDSCH) priority indication; determining a priority for each of a two or more PDSCHs transmissions based on the multi-PDSCH priority indication; determining one or more scheduling parameters for each of the two or more PDSCH transmissions based on the determined priority of each of the two or more PDSCH transmissions; and receiving each of the two or more PDSCH transmissions using the respective determined scheduling parameters. The method may further compromise associating a first scheduling parameter with a first priority and a second scheduling parameter with a second priority, wherein the first priority is a high priority and the second priority is a low priority.

The multi-PDSCH priority indication may indicate a number of high priority PDSCH transmissions, wherein the high priority PDSCHs are transmitted prior to low priority PDSCH transmissions. The DCI may include a bitmap that indicates the priority of each of the two or more PDSCH transmissions. The one or more scheduling parameters may be at least one of the following: repetition number, time location, demodulation reference signal (DMRS) pattern, DMRS density, and modulation and coding scheme (MCS).

A method performed by a WTRU may compromise: receiving a DCI, wherein the DCI includes a multi-physical uplink channel shared channel (PUSCH) priority indication; determining a priority for each of a two or more PUSCH transmissions based on the multi-PUSCH priority indication; determining one or more scheduling parameters for each of the two or more PUSCH transmissions based on the determined priority of each of the two or more PUSCH transmissions; and transmitting each of the two or more PUSCH transmissions using the respective determined scheduling parameters. The method may further compromise associating a first scheduling parameter with a first priority and a second scheduling parameter with a second priority, wherein the first priority is a high priority and the second priority is a low priority.

The DCI includes a bitmap that indicates the priority of each of the two or more PUSCH transmissions. The one or more scheduling parameters may be at least one of the following: repetition number, time location, DMRS pattern, DMRS density, and MCS.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an exemplary multi-PDSCH scheduling by a single-DCI where 4 PDSCH transmissions are scheduled;

FIG. 3 is a diagram illustrating an exemplary multi-TRP transmission with slot level TDM;

FIG. 4 is a diagram illustrating an exemplary multi-PDSCH scheduling for multi-TRP transmissions with different TCI state mapping patterns (TCI-MPs) where the number of repetitions is equal to 2;

FIG. 5 is a diagram illustrating an exemplary TCI state mapping based on TDRA;

FIG. 6 is a diagram illustrating an exemplary TCI state mapping with TCI-MP1 where the number of repetitions is greater than 2 and is even;

FIG. 7 is a diagram illustrating an exemplary TCI state mapping with TCI-MP1 where the number of repetitions is greater than 2 and is odd;

FIG. 8 is a diagram illustrating an exemplary TCI state mapping with TCI-MP3 where the number of repetitions is greater than 2; and

FIG. 9 is a diagram illustrating an exemplary a multi-PDSCH scheduling for multi-TRP transmission with repetitions and frequency hopping.

### DETAILED DESCRIPTION

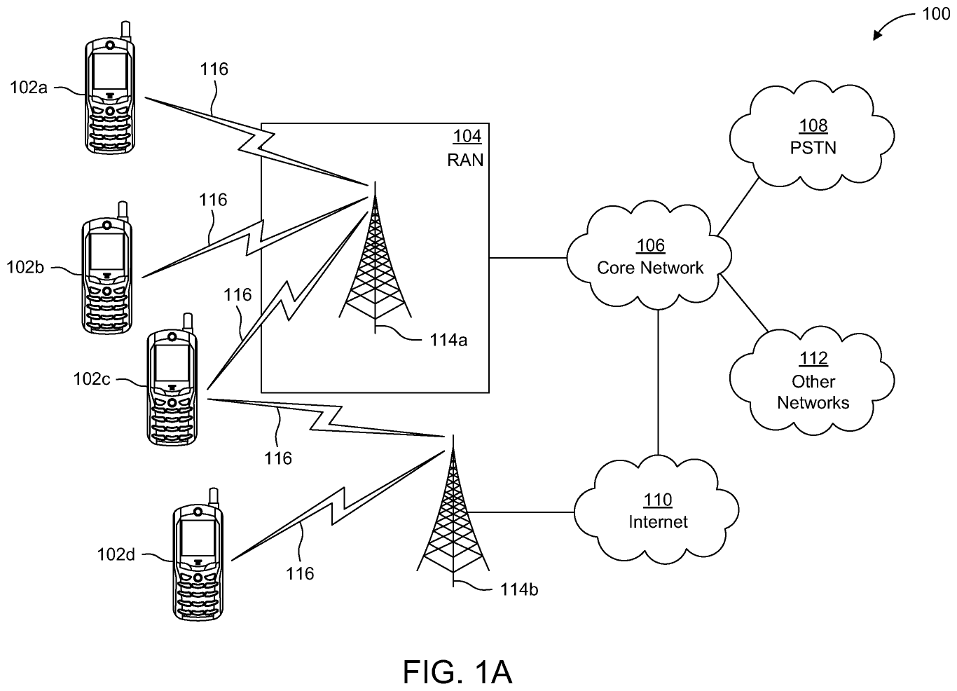

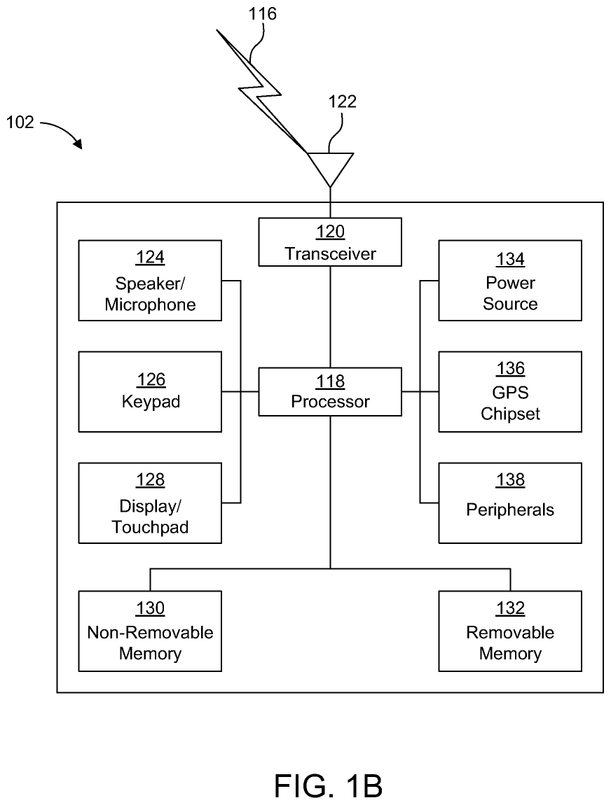

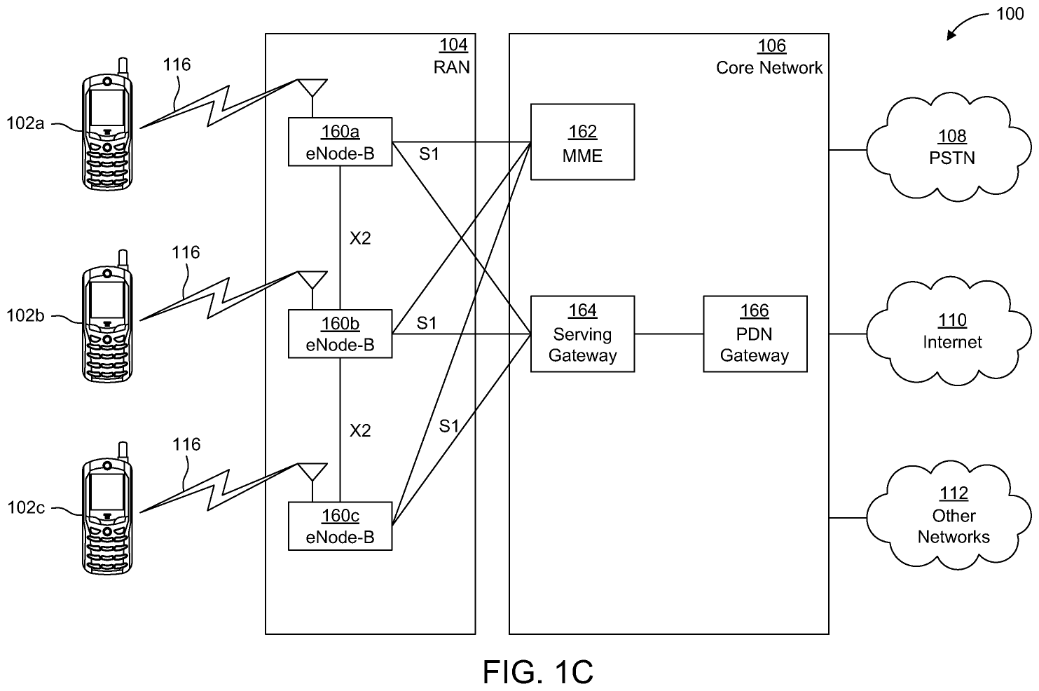

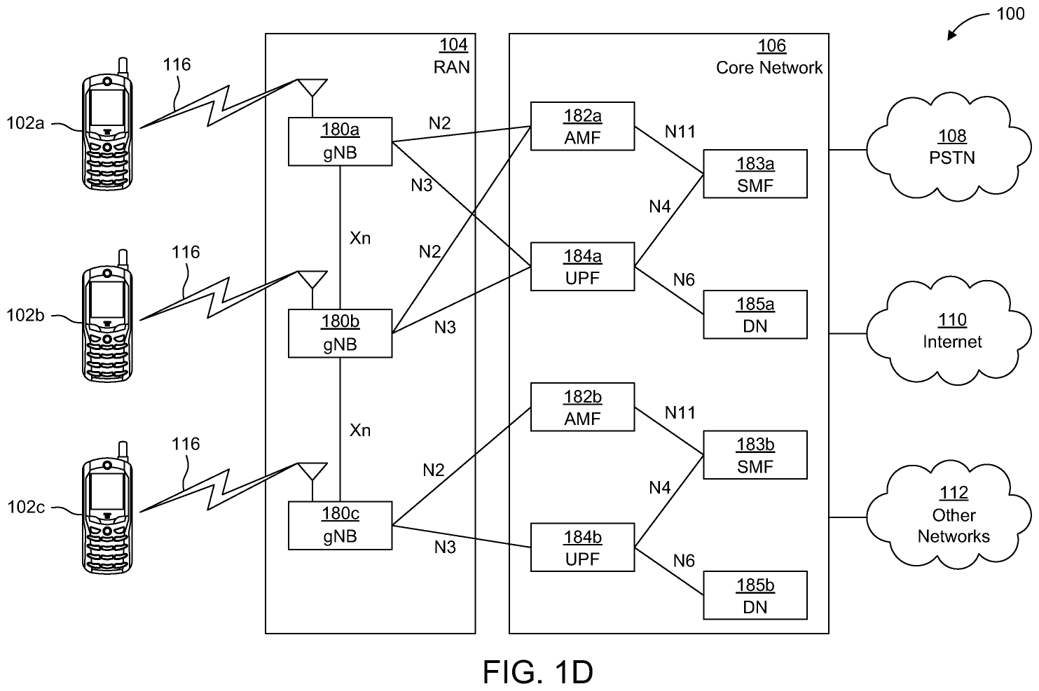

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a. 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a. 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:
Δf Sub-Carrier Spacing
K0 PDSCH scheduling offset in number of slots
K2 PUSCH scheduling offset in number of slots
gNB gNodeB
AP Aperiodic
BFR Beam Failure Recovery
BFD-RS Beam Failure Detection-Reference Signal
BLER Block Error Rate
BWP Bandwidth Part
CA Carrier Aggregation
CB Contention-Based
CDM Code Division Multiplexing
CG Cell Group
COMP Coordinated Multi-Point transmission/reception
CP Cyclic Prefix
CPE Common Phase Error
CP-OFDM Conventional OFDM
CQI Channel Quality Indicator
CN Core Network
CRC Cyclic Redundancy Check
CSI Channel State Information
CSI-RS Channel State Information-Reference Signal
CU Central Unit
D2D Device to Device Transmissions
DC Dual Connectivity
DCI Downlink Control Information
DL Downlink
DMRS Demodulation Reference Signal
DRB Data Radio Bearer
DU Distributed Unit
EN-DC E-UTRA-NR Dual Connectivity
EPC Evolved Packet Core
FD-CDM Frequency Domain-Code Division Multiplexing
FDD Frequency Division Duplexing
FDM Frequency Division Multiplexing
ICI Inter-Cell Interference
ICIC Inter-Cell Interference Cancellation
IP Internet Protocol
LBT Listen-Before-Talk
LCH Logical Channel
LCID Logical Channel Identity
LCP Logical Channel Prioritization
LLC Low Latency Communications
LTE Long Term Evolution
MAC Medium Access Control
MAC CE Medium Access Control Element
NACK Negative ACK
MBMS Multimedia Broadcast Multicast System
MCG Master Cell Group
MCS Modulation and Coding Scheme
MIMO Multiple Input Multiple Output
MTC Machine-Type Communications
MR-DC Multi-RAT Dual Connectivity
NAS Non-Access Stratum
NCB-RS New candidate beam-Reference Signal
NE-DC NR-RAN-E-UTRA Dual Connectivity
NR New Radio
NR-DC Dual Connectivity with
OFDM Orthogonal Frequency-Division Multiplexing
OOB Out-Of-Band (emissions)
Pcmax Total available WTRU power in a given transmission interval
Pcell Primary cell of Master Cell Group
PCG Primary Cell Group
PDU Protocol Data Unit
PER Packet Error Rate
PHY Physical Layer
PLMN Public Land Mobile Network
PLR Packet Loss Rate
PRACH Physical Random Access Channel
PRB Physical Resource Block
PRS Positioning Reference Signal
Pscell Primary Cell of a Secondary Cell Group
PSS Primary Synchronization Signal
PT-RS Phase Tracking-Reference Signal
QoS Quality of Service
RAB Radio Access Bearer
RAN PA Radio Access Network Paging Area
RACH Random Access Channel (or procedure)
RAR Random Access Response
RAT Radio Access Technology
RB Resource Block
RCU Radio Access Network Central Unit
RF Radio Front End
RE Resource Element
RLF Radio Link Failure
RLM Radio Link Monitoring
RNTI Radio Network Identifier
ROM Read-Only Mode (for MBMS)
RRC Radio Resource Control
RRM Radio Resource Management
RS Reference Signal
RTT Round-Trip Time
SCG Secondary Cell Group
SCMA Single Carrier Multiple Access
SCS Sub-Carrier Spacing
SDU Service Data Unit
SOM Spectrum Operation Mode
SP Semi-persistent
SpCell Primary Cell of a Master or Secondary Cell Group.
SRB Signaling Radio Bearer
SS Synchronization Signal
SRS Sounding Reference Signal
SSS Secondary Synchronization Signal
SUL Supplementary Uplink
SWG Switching Gap
TB Transport Block
TBS Transport Block Size
TCI Transmission Configuration Index
TDD Time-Division Duplexing
TDM Time-Division Multiplexing
TI Time Interval
TTI Transmission Time Interval
TRP Transmission/Reception Point
TRPG Transmission/Reception Point Group
TRS Tracking Reference Signal
TRx Transceiver
UL Uplink
WTRU Wireless Transmit/Receive Unit
URC Ultra-Reliable Communications
URLLC Ultra-Reliable and Low Latency Communications
V2X Vehicular Communications
WLAN Wireless Local Area Network

For reception of multi-PDSCH scheduled by a single DCI with URLLC services, a WTRU may receive a configuration of inter-slot repetition type per TDRA codepoint for multi-PDSCHs scheduled by a single DCI. The WTRU may receive a DCI indicating a TDRA codepoint (indicating N time domain resource allocations for N PDSCHs) and several high priority packets of multi-PDSCHs. The WTRU may determine. a repetition number K for high priority PDSCHs and a repetition number L for low priority PDSCHs. If no repetition is indicated, K=1 and L=1. If repetition for high priority PDSCHs is indicated, K may be an indicated value by the TDRA information and L=1. If repetition for all PDSCHs is indicated, K and L may indicate values by the TDRA information.

The WTRU may receive the scheduled multi-PDSCHs based on TDRA information associated with the TDRA codepoint and the number of high priority packets. The WTRU may receive N high priority packets first and M-N low priority packets last within one repetition. The WTRU may receive N high priority packets K times and M-N low priority packets L times. The WTRU may report ACK/NACK after X (<K and/or L) PDSCH receptions. X may be based on an indicated PUCCH resource indication in the scheduling DCI. The may receive failed PDSCHs first and skips decoding of retransmission of the successfully decoded PDSCHs based on the WTRU report.

A WTRU may support different PDSCH scheduling parameters based on indicated priority for each PDSCH. An MCS codepoint may indicate two MCSs—(1) if high priority, it uses the first MCS or lower LCS or (2) if low priority, it uses second MCS or higher MSC. Other parameters include: (1) repetition number (e.g., applicable only to high priority PDSCHs); (2) DMRS type and density (e.g., high density DMRS for high priority PDSCHs); (3) rank (e.g., low rank for high priority PDSCHs); (4) enable/disable frequency hopping (e.g., frequency hopping for high priority PDSCHs)

A WTRU may determine TDRA for repetitions of each PDSCH. The WTRU may receive a DCI indicating a TDRA codepoint (indicating N time domain resource allocations for N PDSCHs). The WTRU may determine transmission occasions (slots) of each PDSCH repetition based on DCI indicated TDRA codepoint. If TDRA entries for each PDSCH indicates one K0 value per repetition, transmission occasions of repetitions may be determined by multiple K0 values. If TDRA entries for each PDSCH indicates one K0 value and an offset per repetition (offset(1), offset(2), etc.), transmission occasion of kth repetition may be given by K0+offset(k).

A WTRU may also determine SLIV configuration of each PDSCH repetition based on DCI indicated TDRA codepoint. If TDRA entries for each PDSCH indicates one SLIV configuration per PDSCH, the same SLIV configuration may be applied for each repetition. If TDRA entries for each PDSCH indicates one SLIV configuration per repetition, each repetition may be configured with configured SLIVs.

Above 52.6 GHz bands have the potential for larger spectrum allocation that are not available for bands lower than 52.6 GHZ. However, the systems operating in above 52.6 GHz frequencies are faced with more difficult challenges, such as higher phase noise, extreme propagation loss due to high atmospheric absorption, lower power amplifier efficient, and strong regulatory requirements on power spectral density, compares to lower frequency bands. Further, physical layer design of NR was originally designed to be optimized for under 52.6 GHz frequencies. To overcome some of these challenges, In RAN #90, an update WID was agreed to extend the NR operation to 71 GHz considering operation in both licensed and unlicensed bands. As part of the new WID, scheduling multiple PDSCHs by a single DCI was agreed.

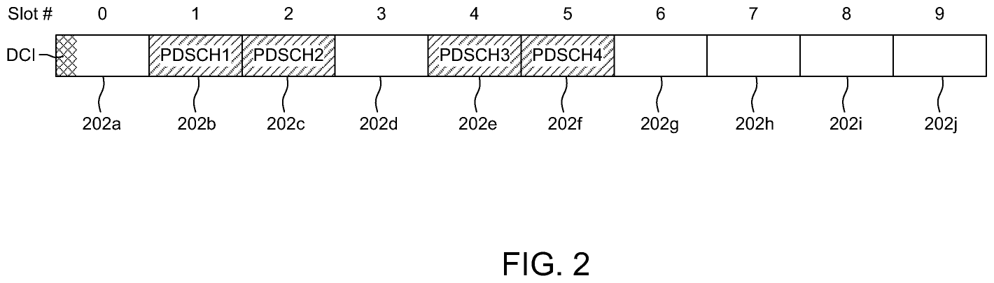

FIG. 2 shows an example configuration of multi-PDSCH scheduling by a single-DCI based where there are four PDSCHs scheduled. As shown in FIG. 2, the multi-PDSCH scheduling includes slots 202a-202j. The single DCI may be located within slot 202a, while the PDSCHs may be scheduled in slots 202b, 202c, 202e, and 202f.

Several extensions to multi-PDSCH scheduling by a single DCI is proposed. These extensions are based on multi-TRP transmission. In multi-TRP transmission, the same PDSCH is repeated via 2 TRPs using TDM, FDM or SDM to support both URLLC and eMBB use cases.

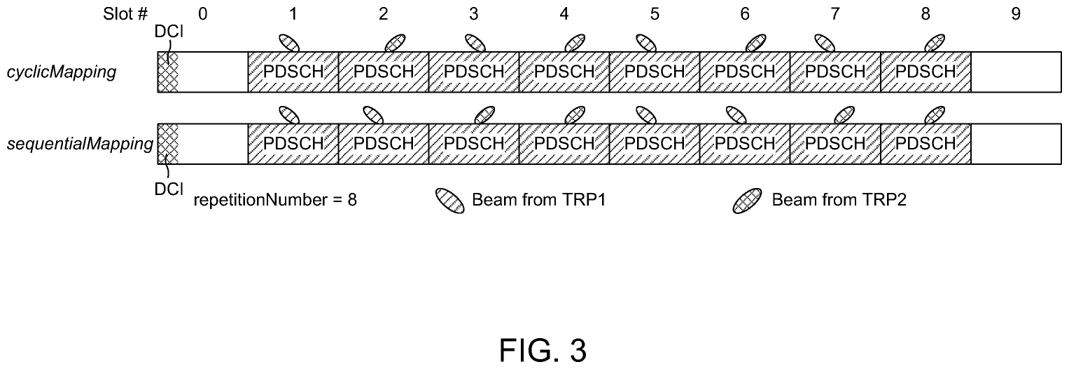

FIG. 3 shows an example multi-TRP transmission configuration with two TRPs and slot-level TDM where there are 8 repetitions. With cyclicMapping, a WTRU may receive each consecutive repetition of the PDSCH from a different TRP. With sequentialMapping, a WTRU may receive two repetitions of the PDSCH from the first TRP. In the subsequent two slots, the WTRU receives two repetitions of the PDSCH from the second TRP.

Supporting multi-TRP transmission for higher carrier frequencies, in FR2-2 (52.6 GHz to 71 GHZ) for example, requires several new solutions. In some instances, multi-TRP transmission only supports repetition of a single PDSCH. However, in other instances, multiple PDSCHs are scheduled by a single DCI. Therefore, new solutions are required to support repetitions of multiple PDSCHs scheduled by a single DCI in an efficient manner.

Further, in certain FR2-2 designs, all PDSCHs scheduled by a single DCI may only be configured with a single priority level and an MCS. This may be limiting and allowing different priority level PDSCHs to be scheduled by a single DCI may be important when multiple PDSCHs are scheduled by a single DCI. Also, some multi-TRP which are designed for licensed spectrum, solutions for high frequency communications, FR2-2 for example, should be capable of supporting both licensed and unlicensed spectrum.

One embodiment may enable scheduling PDSCHs with different priority levels together by the same control channel signaling. Another embodiment may enable WTRU determining the priority level of PDSCHs. Another embodiment may enable achieving high reliability transmission by using multiple repetitions over multiple TRPs. Another embodiment may improve the resource utilization efficiency in repletion transmissions in multi-PDSCH scheduling. Another embodiment may enable switching modulation based on beam pair in use.

A WTRU may transmit or receive a physical channel or reference signal according to at least one spatial domain filter. Hereinafter, the term “beam” may be used to refer to a spatial domain filter.

A WTRU may transmit a physical channel or signal using the same spatial domain filter as the spatial domain filter used for receiving an RS (such as CSI-RS) or an SS block. The WTRU transmission may be referred to as “target,” and the received RS or SS block may be referred to as “reference” or “source.” In such a case, the WTRU may transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such a case, the WTRU may transmit the first (target) physical channel or signal according to a spatial relation with a reference to the second (reference) physical channel or signal.

A spatial relation may be implicit, configured by RRC, or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication.”

A WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication.”

In an embodiment, a WTRU may receive DCI scheduling to receive one or more PDSCHs and/or to transmit one or more PUSCHs. The one or more PDSCHs and/or the one or more PUSCHs may include a set of low priority PDSCHs/PUSCHs and a set of high priority PDSCHs/PUSCHs. The WTRU may determine the set of low priority PDSCHs/PUSCHs and the set of high priority PDSCHs/PUSCHs based on one or more of following: (1) explicit indication; (2) number of high priority PDSCHs/PUCCHs/PUSCHs; (3) priority indication per time domain resource allocation (TDRA); (4) priority indication per frequency domain resource allocation (FDRA); and/or (5) indication of PUCCH resource for HARQ-ACK and PDSCH-to-HARQ-ACK delay.

A WTRU may receive an explicit indication of priority levels for the one or more PDSCHs and/or associated HARQ-ACK and/or PUCCH and/or the PUSCHs. For example, the WTRU may receive a bitmap which includes X bits wherein X equals to number of PDSCHs and/or PUSCHs. Each bit of X bits may indicate a priority level of each PDSCH/HARQ-ACK/PUCCH/PUSCH. For example, if the bit=‘0’, the associated PDSCH/PUCCH/PUSCH may be a low priority PDSCH/PUSCH. If the bit=‘1’, the associated PDSCH/PUCCH/PUSCH may be a high priority PDSCH/PUSCH. The indication may be based on one or more of RRC, MAC CE and DCI. For DCI based indication, the WTRU may be configured with one or more bitmaps and each bitmap may be associated with each codepoint of a DCI field (e.g., priority indication for multi-PDSCHs/PUSCHs). The WTRU may receive a codepoint and determine an associated bitmap with the indicated codepoint to determine priorities of multi-PDSCHs/PUSCHs.

A WTRU may receive an indication of number of high priority (or low priority) PDSCHs/PUCCHs/PUSCHs (e.g., via DCI and/or MAC CE). For example, the WTRU may receive a first number for number of high priority PDSCHs/PUCCHs/PUSCHs. Based on the first number, the WTRU may identify high priority PDSCHs/PUCCHs/PUSCHs. For example, the WTRU may receive a scheduling of M PDSCHs/PUSCHs and an indication of N high priority PDSCHs/PUSCHs. Based on the indicated M and N, the WTRU may determine the priority of the scheduled PDSCHs/PUSCHs.

The first (or last) N PDSCHs/PUSCHs may be high priority PDSCHs/PUSCHs and remaining M-N PDSCHs/PUSCHs may be low priority PDSCHs/PUSCHs. The WTRU may determine a position of high priority PDSCHs/PUSCHs based on timeDurationForQCL. For example, if timeDurationForQCL≤Scheduled offset of PDSCHs/PUSCHs (e.g., scheduled offset of a first PDSCH/PUSCH), the WTRU may receive/transmit N high priority PDSCHs/PUSCHs first and receive/transmit M-N high priority PDSCHs/PUSCHs last. If timeDurationForQCL>Scheduling offset of PDSCH (e.g., scheduled offset of a first PDSCH/PUSCH), the WTRU may receive/transmit M-N low priority PDSCHs/PUSCHs first and receive/transmit N high priority PDSCHs/PUSCHs last.

A WTRU may receive a priority indication as a part of a TDRA. For example, the WTRU may receive multiple TDRAs where each TDRA may include information associated with a PDSCH/PUSCH of scheduled multiple PDSCHs/PUSCHs. Based on the information included in the TDRA, the WTRU may determine a priority of an associated PDSCH/PUSCH. The information included in the TDRA may include information one or more of following: (1) priority indication; (2) start symbol; (3) length; (4) slot offset; (5) start symbol and length indicator (e.g., SLIV); (6) mapping type; (7) a number of repetitions; and/or (8) a waveform type configuration.

For example, each TDRA may include an associate number of repetitions. The WTRU may apply different number of repetitions for each PDSCH. For example, the WTRU may receive/transmit A repetitions for a first PDSCH/PUSCH and B repetitions for a second PDSCH/PUSCH based on the associated number of repetitions in an associated TDRA.

In an embodiment, a WTRU may receive a priority indication as a part of a FDRA. For example, the WTRU may receive multiple FDRAs and each FDRA may include information associated with a PDSCH/PUSCH of scheduled multiple PDSCHs/PUSCHs. Based on the information, the WTRU may determine a priority of an associated PDSCH/PUSCH. The information may include one or more of following: (1) a bitmap of resource block groups (RBGs); (2) start RB and/or (3) length.

In an embodiment, a WTRU may receive a first and second PUCCH resource indicator for a PUCCH of first and second priority index respectively. The first indicated PUCCH may carry a HARQ-ACK for PDSCHs of first priority index, while the second indicated PUCCH may carry a HARQ-ACK for PDSCHs of second priority index. The WTRU may additionally receive a first and second PDSCH-to-HARQ-ACK delay indication indicating the timing of the first and second PUCCH transmissions in units of slot or sub-slot according to respective first and second PUCCH configuration. In case the first and second PUCCH overlap in time, the WTRU may multiplex HARQ-ACK of first and second priority in one of the PUCCH.

Alternatively, the WTRU may receive a single PUCCH resource indicator for PUCCH. The indicated PUCCH may multiplex a HARQ-ACK for PDSCHs of first and second priority index. The WTRU may encode the HARQ-ACK of first and second priority index using maximum code rate parameters applicable to first and second priority index from the PUCCH configuration corresponding to the indicated PUCCH, provided that applicable conditions for multiplexing are met. For example, the conditions may be met if the code rates of HARQ-ACK of first and second priority index do not exceed the respective configured maximum code rates. In case the conditions are not met, the WTRU may transmit only HARQ-ACK of highest priority index in the PUCCH.

A WTRU may be scheduled to receive one or more downlink/uplink channels and/or signals. One or more scheduling parameter sets used in a BWP may be determined based on the determine priority used for each PDSCH/PUSCH. The scheduling parameter set may include at least one or more of the following: MCS level, modulation order, minimum/maximum scheduling bandwidth, DMRS density, DMRS pattern, frequency resource allocation type, time resource allocation type, number of repetition, slot aggregation number, number of slot for TBoMS configuration, and slot length.

In an embodiment, a first set of scheduling parameters may be used for a PDSCH/PUSCH with a first priority (e.g., low priority) and a second set of scheduling parameters may be used for a PDSCH/PUSCH with a second priority (e.g., high priority).

The first set of scheduling parameter may include a first number of repetition and a first type of repetition and the second set of scheduling parameter may include a second number of repetition and a second type of repetition. For example, a WTRU may receive a DCI scheduling M PDSCHs/PUSCHs and N high priority PDSCHs/PUSCHs of M PDSCHs/PUSCHs. The WTRU may determine a repetition number K for high priority PDSCHs and a repetition number L for low priority PDSCHs. The WTRU may receive a repetition type indication and the repetition type indication may indicate one or more of ‘no repetition’, ‘repetition for high priority’, ‘repetition for low priority’ and ‘repetition for all PDSCHs/PUSCHs’. If no repetition is indicated, K=1 and L=1. If repetition for high priority PDSCHs is indicated, K is an indicated value by a gNB and L=1. If repetition for low priority PDSCHs is indicated, K=1 and the base station indicates the value L. If repetition for all PDSCHs is indicated, the base station indicates values K and L.

The first set of scheduling parameter may include a first subset of modulation order (e.g., 64QAM and 256QAM) and the second set scheduling parameter may include a second subset of modulation order (e.g., 16QAM, and 64QAM).

When a WTRU is in an active BWP associated with a first waveform, the WTRU expect to receive PDSCH with one of the modulation order (or MCS) within the subset associated the BWP (or waveform).

A WTRU may re-receive/re-transmit scheduled PDSCHs/PUSCHs (e.g., based on repetitions) based on one or more of following: (1) priority and/or (2) Hybrid Automatic Repeat Request (HARQ)-Acknowledgement (ACK)/Negative Acknowledgement (NACK).

In an embodiment, a WTRU may re-receive/re-transmit scheduled PDSCHs/PUSCHs based on determined priorities. For example, the WTRU may be configured with a repetition of scheduled PDSCHs/PUSCHs. Based on the configuration, the WTRU may receive a scheduling of M PDSCHs/PUSCHs and N high priority PDSCHs/PUSCHs of the M PDSCHs/PUSCHs. In a first transmission (e.g., based on a first TCI state and/or a first TRP), the WTRU may receive/transmit the scheduled PDSCHs/PUSCHs in a scheduled order. In a second transmission (e.g., based on a second TCI state and/or a second TRP), the WTRU may receive/transmit N high priority PDSCHs/PUSCHs first and M-N low priority PDSCHs/PUSCHs last.

In an embodiment, a WTRU may transmit one or more ACK/NACK reports in a middle of multi-PDSCHs/PUSCHs. For example, the WTRU may receive a DCI scheduling M PDSCHs/PUSCHs and N high priority PDSCHs/PUSCHs of M PDSCHs/PUSCHs. The WTRU may receive an indication of repetition K for high priority packets and L for low priority packets. The WTRU may report ACK/NACK after X.

X may be based on one or more indicated PUCCH resources (e.g., in a scheduling DC). X may also be based on repetition number L or K (e.g., in a DCI field or in TDRA and/or FDRA). For example, the WTRU may determine a first number of repetitions associated L or K (e.g., L/2 or K/2, min (L,K). The WTRU may report ACK/NACK after X repetitions. X may also be based on number of PDSCHs/PUSCHs. For example, the WTRU may determine a first number of receptions/transmissions associated L or K (e.g., N/2). The WTRU may report ACK/NACK after X receptions/transmissions.

If more than one ACK/NACK report is supported in the middle of multi-PDSCHs/PUSCHs, a WTRU may skip reporting of ACK/NACK for successfully decoded/transmitted PDSCHs/PUSCHs in a previous ACK/NACK reporting. For example, the WTRU may report a first reporting for a first PDSCH and a NACK for a second PDSCH. Based on the reporting, the WTRU may report ACK/NACK only for the second PDSCH.

In another example, a WTRU may re-receive/re-transmit PDSCHs/PUSCHs based on the WTRU report (e.g., ACK/NACK). For example, the WTRU may be configured with a repetition of scheduled PDSCHs/PUSCHs. Based on the configuration, the WTRU may receive a scheduling of M PDSCHs/PUSCHs and N high priority PDSCHs/PUSCHs of the M PDSCHs/PUSCHs. In a first transmission (e.g., based on a first TCI state and/or a first TRP), the WTRU may receive/transmit the scheduled PDSCHs/PUSCHs in a scheduled order. In a second transmission (e.g., based on a second TCI state and/or a second TRP), the WTRU may receive/transmit N high priority PDSCHs/PUSCHs first and M-N low priority PDSCHs/PUSCHs last.

In another example, in a first transmission (e.g., based on a first TCI state and/or a first TRP), a WTRU may receive/transmit the scheduled PDSCHs/PUSCHs in a scheduled order. In a second transmission (e.g., based on a second TCI state and/or a second TRP), the WTRU may receive/transmit failed F PDSCHs/PUSCHs first (based on WTRU ACK/NACK). For the remaining M-F PDSCHs/PUSCHs, the WTRU may support one or more of following: (1) the WTRU may receive/transmit remaining M-F PDSCHs/PUSCHs last; or (2) the WTRU may not receive/transmit remaining M-F PDSCHs/PUSCHs and the WTRU may receive/transmit other signals and/or channels in time and frequency resources associated with M-F PDSCHs/PUSCHs.

In an embodiment, a PDSCH may be configured with different number of repetitions. A WTRU may be indicated the number of repetitions as a part of TDRA. For example, a WTRU may be configured with multiple TDRA and each TDRA may include information associated with one or multiple PDSCHs/PUSCHs. Multiple TDRA may be configured by RRC signaling. Alternatively, a WTRU may be configured with multiple TDRAs by RRC signaling and a subset of TDRAs may be activated by MAC-CE. A WTRU may receive a DCI which indicates a codepoint for TDRA configured by RRC or configured and activated by RRC and MAC-CE signaling.

In an explicit indication, the number the number of repetitions of each PDSCH/PUSCH may be included in the TDRA of each PDSCH/PUSCH separately. In another example, TDRA may include a bitmap and each bit of the bitmap may indicate repetition number of each scheduled PDSCH/PUSCH (e.g., 1 bit with bit value ‘1’ indicating N number of repetitions and bit value ‘0’ indicating M number of repetitions for the corresponding PDSCH/PUSCH.)

In an implicit indication, the TDRA may include one or more of the following information for each scheduled PDSCH/PUSCH: (1) SLIV for each PDSCH/PUSCH or multiple SLIVs wherein each SLIV is associated with each PDSCH/PUSCH and its repetitions; (2) start symbol for each PDSCH/PUSCH or multiple start symbols wherein each stat symbol is associated with each PDSCH/PUSCH and its repetitions; (3) length for each PDSCH/PUSCH or multiple length values wherein each length value is associated with each PDSCH/PUSCH and its repetitions; (4) slot offset K0/K2 of each PDSCH/or multiple KOs/K2s wherein each K0/K2 is associated with each PDSCH/PUSCH and its repetitions; (5) mapping type for each PDSCH/PUSCH or multiple mapping types wherein each mapping type is associated with each PDSCH/PUSCH and its repetitions; (6) priority level of each PDSCH/PUSCH; and/or (7) priority levels of each PDSCH/PUSCH and its repetitions indicated/configure for cancellation indication.

If the TDRA includes the priority level of each PDSCH/PUSCH, the priority level indicated for each PDSCH may implicitly indicates the number of repetitions. For example, with two priority levels high and low indicated by 1 and 0, 1 corresponds to N number of repetitions and 0 corresponds to M number of repetitions.

If the TDRA includes the priority levels of each PDSCH/PUSCH and its repetitions indicated/configure for cancellation indication, each repetition of a PDSCH/PUSCH may assign a priority level as a part of TDRA to indicate applicability of cancellation indication (CI). For example, if the TDRA determined for the multi-PDSCHs/PUSCHs scheduled by a single DCI indicates N number of priority levels to indicate the applicability of CI, number of repetitions is N.

A WTRU may receive DCI. The DCI may carry information regarding a TDRA codepoint. One or more PDSCHs/PUSCHs may be repeated over time and/or frequency, where the WTRU may determine the respective scheduling information for the allocated time and frequency RBs from the corresponding DCI. The scheduling information may carry TCI states associating the scheduled PDSCHs/PUSCHs with one or more Transmission Reception Points (TRPs) and/or panels. The multi-TRP/panel operation may be used to repeat PDSCHs/PUSCHs in time and/or frequency domain.

One or more scheduling schemes for the multi-TRP PDSCH/PUSCH repetition may be used, defined, configured, or determined. The PDSCHs may be transmitted from one TRP and/or panel may be repeated by another TRP and/or panel. The PUSCHs may be transmitted from a WTRU to one or more TRPs and/or gNB panels. One or more repetition mappings may be used, defined, configured, or determined.

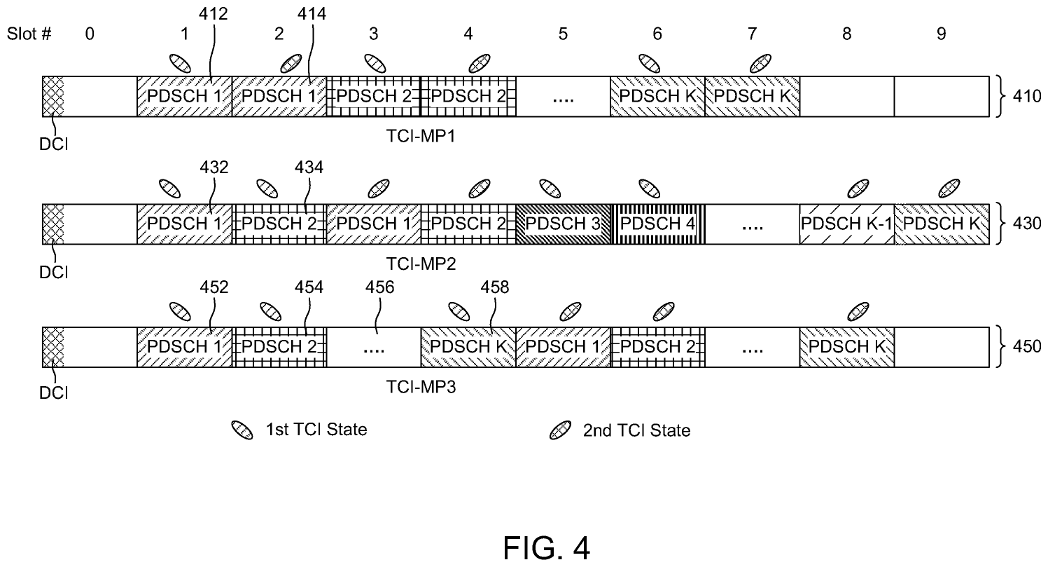

FIG. 4 is a diagram illustrating an exemplary multi-PDSCH scheduling for multi-TRP transmissions with different TCI state mapping patterns (TCI-MPs) where the number of repetitions is equal to 2. TCI-MP1 410 in FIG. 4 shows cyclic mapping, where first and second TCI states are applied to the first PDCCH occasion 412 and second PDSCH occasion 414, respectively, and the same mapping pattern continues to the remaining PDSCHs Tx occasions.

Sequential mapping is shown in TCI-MP2 430 and TCI-MP3 450. In sequential mapping, the first TCI state is applied to a number and/or a group of PDSCH occasions.

In TCI-MP2 430, the first TCI is applied to the first PDSCH occasion 432 and second PDSCH occasion 434. The second TCI state is applied to similar number and/or group of PDSCH/PUSCH occasions, and the same mapping pattern continues to the remaining PDSCH/PUSCH occasions. In TCI-MP3 450, the first TCI is applied to at least the first PDSCH occasion 452, PDSCH occasion 454, PDSCH occasion 456, and PDSCH occasion 458. The second TCI state is applied to similar number and/or group of PDSCH/PUSCH occasions, and the same mapping pattern continues to the remaining PDSCH/PUSCH occasions.

For operation with shared spectrum channel access, Listen Before Talk (LBT) is mandatory in many regions. As such, Clear Channel Assessment (CCA) may be performed before every single transmission using energy sensing. Considering transmission of PDSCH/PUSCH blocks, NodeB may transmit only upon successful sensing of channel to be idle. The NodeB then may transmit for duration up to Channel Occupancy Time (COT), which is determined based on a priority class.

The defer duration T_{d} may consists of duration T_{f}=16 us immediately followed by mₚ consecutive slot durations where each slot duration may be Tₛₜ=9 us, and T_{f} includes an idle slot duration Tₛₜ at start of T_{f}. Thus, the minimum length for LBT is 25 us.

During the channel occupancy, transmission gaps of less than or equal to 25 μs are allowed and are counted in the channel occupancy time. The channel occupancy time may be used by the base station and corresponding WTRU(s) through downlink or uplink transmission bursts, respectively. A transmission burst implies a set of transmissions with no gaps larger than 16 μs. If the gaps exceed the limit of 16 μs, the transmission may continue in a separate transmission burst after sensing the channel to be clear/idle.

Hereafter, operation with or without shared spectrum channel access may be interchangeably used with unlicensed or licensed bands, respectively. The term unlicensed spectrum may be used to refer to license exempt spectrum and lightly licensed spectrum.

When operating in high frequencies in unlicensed band, the switching between multi-TRPs during downlink transmissions and sub-slot level and/or slot-level repetition in time domain may result in frequent LBT requirements. Also, the limit of the COT may be considered in prioritizing the scheduling of multiple PDSCH transmissions. Therefore, methods may be considered to account for COT and the missed PDSCH due to the LBT failure.

In an embodiment, a WTRU may determine that one or more of the scheduled PDSCHs/PUSCHs are not received/transmitted in the scheduled time and/or frequency RBs (e.g., due to the LBT failure). In an example, a WTRU may determine that one or more PDSCHs/PUSCHs associated with the first TCI state (e.g., first TRP and/or panel), were not received at the scheduled time and/or frequency RBs. For example, in TCI-MP3 450 in FIG. 4, the WTRU may determine that PDSCH 2 454 and PDSCH K 458 (e.g., PDSCH 4 in an instance that K=4) were not received in corresponding frequency RBs in Slot #2 and Slot #4, respectively.

Upon successful channel access from the other TCI state (e.g., second TRP and/or panel), a WTRU may determine that the missed PDSCHs/PUSCHs may be prioritized to be received with higher priority. In an example, the WTRU may determine that the order of the reception of the PDSCH or the transmission of the PUSCH from the second TCI state (e.g., second TRP and/or panel) is to first receive the missed PDSCHs/PUSCHs followed by the repetition of the PDSCHs/PUSCHs that were received in the scheduled time and/or frequency RBs during the PDSCH reception from the first TCI state, e.g., first TRP and/or panel. For example, in TCI-MP3 450 in FIG. 4, the order may be PDSCH 2 454, PDSCH K 458 (e.g., PDSCH 4 in an instance that K=4) and then PDSCH 1 452 and PDSCH 3 456.

One or more TCI state mapping types may be used, defined, configured, or determined. For example, as seen in FIG. 4, a WTRU may be configured with TCI-MP1 410, TCI-MP2 430, and/or TCI-MP3 450. The WTRU may receive an indication from the NodeB, e.g., RRC, MAC CE, and/or DCI, on which TCI state mapping to use.

In an embodiment, one or more limits and/or thresholds may be used, defined, configured, or determined for the remaining time in the COT that is initiated by the corresponding NodeB (e.g., TRP/panel). The limits and/or thresholds on the remaining time may be based on the number of slots, symbols, and/or a (pre) configured time period. A limit and/or threshold may be mutually exclusive to another limit and/or threshold.

In an embodiment, a WTRU may determine the TCI state mapping based on the association with the limits and/or thresholds on the remaining time in the COT. In an example, a first limit and/or threshold on the remaining time in the COT may be associated with a first TCI state mapping type; a second limit and/or threshold on the remaining time in the COT may be associated with a second TCI state mapping type, and so forth.

In one example, a WTRU may determine TCI-MP3 450 in FIG. 4 with higher priority than the other TCI state mappings if only a limited number of slots is remaining within the COT (e.g., four slots remaining). In another example, the WTRU may determine TCI-MP2 430 in FIG. 4 with higher priority than the other TCI state mappings if only a limited number of slots is remaining within the COT (e.g., two slots remaining).

Alternatively, one or more priority levels and/or types may be used, defined, configured, or determined for the scheduled PDSCHs. A WTRU may receive an indication from the NodeB (e.g., RRC, MAC CE, and/or DCI), on the priority levels and/or types for the PDSCH scheduled transmission.

In an embodiment, one or more limits and/or thresholds may be used, defined, configured, or determined based on the priority levels and/or types for the scheduled PDSCHs/PUSCHs. As such, a WTRU may determine a TCI state mapping type in association with the limits and/or thresholds on the PDSCH/PUSCH priority levels and/or types.

In one example, a first limit and/or threshold on the priority level and/or type for the scheduled PDSCHs/PUSCHs may be associated with a first TCI state mapping type; a second limit and/or threshold on the priority level and/or type for the scheduled PDSCHs/PUSCHs may be associated with a second TCI state mapping type, and so forth. The thresholds may be based on the priority levels and/or types, the number of different priority levels and/or types that are scheduled, and/or the number of scheduled PDSCHs/PUSCHs with higher priority levels and/or types.

In an embodiment, a WTRU may determine a TCI state mapping type based on the number of configured priority levels for the multiple scheduled PDSCHs/PUSCHs. For example, if the number of PDSCHs/PUSCHs with different priority levels are greater that the configured threshold (e.g., four), the WTRU may determine a TCI state mapping type that is associated with that threshold (e.g., TCI-MP3 450 in FIG. 4).

In an embodiment, a WTRU may determine a TCI state mapping type based on the number of scheduled PDSCHs/PUSCHs configured with higher priority levels. For example, if the number of PDSCHs with higher priority is more than a threshold, e.g., four, the WTRU may determine TCI state mapping type that is associated with that threshold (e.g., TCI-MP3 450 in FIG. 4).

In another embodiment, one or more priority levels and/or types may be used, defined, configured, or determined for the PDSCH reception/PUSCH transmission from the second TCI state (e.g., second TRP and/or panel), when the respective PDSCH reception/PUSCH transmission from the first TCI state (e.g., for first TRP and/or panel), was missed (e.g., due to LBT failure). In an example, a WTRU may determine that one or more PDSCH associated with the first TCI state, e.g., for first TRP and/or panel, were not received at the scheduled time and/or frequency RBs.

Upon successful channel access from the other TCI state (e.g., for second TRP and/or panel), a WTRU may determine that there are one or more priority types and/or levels associated with the missed PDSCHs/PUSCHs. As such, the order of transmission of the missed PDSCHs/PUSCHs from the second TCI state, e.g., for second TRP and/or panel, may be based on the respective priority type and/or level. In an example, the WTRU may determine that the order of the reception of the PDSCH or the transmission of the PUSCH from the second TCI state (e.g., for second TRP and/or panel) is to first receive the missed PDSCH/PUSCH with the highest priority type and/or level, followed by the reception of the other missed PDSCHs/PUSCHs with lower priority type and/or level, and then followed by the repetition of the PDSCHs/PUSCHs that were received in the scheduled time and/or frequency RBs during the PDSCH reception/PUSCH transmission from the first TCI state, e.g., first TRP and/or panel.

For example, a WTRU may determine that PDSCH2 and PDSCH4 were not received from the first TCI state, (e.g., first TRP and/or panel), in corresponding frequency RBs in Slot #2 and Slot #4 in TCI-MP3 in FIG. 4, respectively. In an example, the WTRU may determine that PDSCH4 has a higher priority type and/or level compared to the PDSCH2. Therefore, the WTRU may determine that the order to receive the PDSCH from the second TCI state, e.g., second TRP and/or panel, may be PDSCH4, PDSCH2 and then repetition of PDSCH1 and PDSCH3 in TCI-MP3 in FIG. 4.

In another embodiment, one or more TDRA configuration types may be used, defined, configured, or determined. In a first TDRA configuration, a WTRU may be configured with consecutive PDSCH slots without slot level gaps. In the second TDRA configuration, the WTRU may be configured with slot level gaps between the scheduled PDSCH slots. In an example, a WTRU may receive an indication from the NodeB, e.g., RRC, MAC CE, and/or DCI, on which TDRA configuration to use.

In one embodiment, a WTRU may receive one or more configurations to use, transmit, and/or occupy the gap slots for the uplink transmission without LBT, e.g., SRS, PUSCH, and/or PUCCH. The transmission and/or channel occupancy duration may be limited in time. One or more of the following may apply: (1) MCOT duration; (2) schedule time resources; (3) preconfigured time periods; and/or (4) frame duration.

For MCOT duration, a WTRU may transmit and/or occupy the channel to the extent of the available COT, initiated by the first or second TRP and/or panel associated to the first or second TCI states, respectively.

For schedule time resources, a WTRU may transmit and/or occupy the channel to the extent of the gap slot in between the scheduled PDSCH transmissions and/or repetitions from the first or second TRP and/or panel associated to the first or second TCI states, respectively.

For preconfigured time periods, a WTRU may be configured to transmit and/or occupy the channel based on a predefined and/or a configured period.

For frame duration, a WTRU may transmit and/or occupy the channel to the extent of the number of slot and/or symbols, and/or a number of slots till the next Fixed Frame Period (FFP) LBT opportunity/IDLE period in a Frame Based Equipment (FBE) frame configuration.

In another embodiment, the WTRU may transmit and/or occupy the gap slots without LBT after successful detection of the PDSCH occupancy from a TRP and/or panel with a corresponding QCL index. The WTRU may determine to use the spatial filter for the uplink transmission in association with the QCL index of the corresponding TRP and/or panel.

The transmission and/or channel occupancy may be conditioned on one or more of the following: (1) MCOT duration; (2) scheduled PDSCH; (3) frame configuration.

For MCOT duration, a WTRU may determine that the remaining time in the COT initiated by corresponding TRP/panel for PDSCH transmission is greater than a (pre) configured time threshold.

For scheduled PDSCH, a WTRU may determine that the remaining time in the number of slots and/or symbols till the next scheduled PDSCH transmission from the corresponding TRP/panel is greater than a (pre) configured time threshold.

For frame configuration, a WTRU may determine that the remaining time in the number of slot and/or symbols, and/or a number of slots till the next Fixed Frame Period (FFP) LBT opportunity/IDLE period in a Frame Based Equipment (FBE) frame configuration is greater than a (pre) configured time threshold.

A WTRU may receive a DCI which may include scheduling information for one or more PDSCHs, wherein each PDSCH may carry a transport block (TB). The scheduling information may include TCI state associated with the one or more PDSCHs. When a scheduling offset of a PDSCH among the one or more PDSCHs is less than timeDurationForQCL, a default beam (e.g., TCI state of the CORESET with the lowest CORESET-id in a slot) may be used for the PDSCH. Otherwise, the indicated beam (e.g., TCI state in the DCI) may be used for the PDSCH.

For the one or more PDSCHs scheduled by a DCI may be associated with a different TCI state. For example, a first set of PDSCHs may be associated with a default beam and a second set of PDSCHs may be associated with an indicated beam in the DCI.

In an embodiment, a different MCS level may be used for the first set of PDSCHs (e.g., associated with a default beam) and the second set of PDSCHs (e.g., associated with an indicated beam in the DCI). For example, a first MCS level may be used for the first set of PDSCHs and a second MCS level may be used for the second set of PDSCHs, wherein the first MCS level and the second MCS level may be determined based on one or more of following as described below.

The first MCS level may be indicated in the associated DCI and the second MCS level may be determined based on an offset from the first MCS level. The offset may be indicated via a higher layer signaling (e.g., RRC, MAC-CE) or a L1 signaling (e.g., in the associated DCI). The offset may be implicitly indicated by an RNTI scrambled on the CRC of the associated DCI. The offset may be determined based on scheduling parameters (e.g., frequency resource allocated)

A codepoint of MCS indication field may indicate the first MCS level and the second MCS level.

A two stage DCI may be used. For example, a first stage DCI may include scheduling information for the scheduled one or more PDSCHs and MCS level for the first set of PDSCHs; and a second stage DCI may include MCS level for the second set of PDSCHs. The first stage DCI may be monitored in the associated search space and the second stage DCI may be monitored or received in one of the first set of PDSCHs. For example, the second stage DCI may be a part of PDSCH resource within the first set of PDSCHs.

In another embodiment, a different DM-RS pattern and/or density may be used for the first set of PDSCHs and the second set of PDSCHs. In one example, a WTRU may be indicated with a first DM-RS configuration (e.g., pattern, density, number of DM-RS symbols, DMRS type) which may be associated with the first set of PDSCHs and a second DM-RS configuration which may be associated with the second set of the PDSCHs. When a WTRU receives and/or decodes one or more PDSCHs scheduled by a DCI, the WTRU may determine DMRS for the first set of PDSCHs based on the first DM-RS configuration and the WTRU may determine DMRS for the second set of PDSCHs based on the second DM-RS configuration. In another example, the first DMRS for the first set of PDSCHs may be configured via a higher layer signaling for a BWP and the second DMRS for the second set of PDSCHs may be determined as a function of the DM-RS configuration of the first DMRS. The first DM-RS configuration may have higher DM-RS density than the second DM-RS configuration, or vice-versa.

In another embodiment, a different number of layers (e.g., rank) may be used for the first set of PDSCHs and the second set of PDSCHs. For example, a first rank may be used for the first set of PDSCHs and a second rank may be used for the second set of PDSCHs. One or more of following may apply: (1) the first rank may be predefined as rank=1; (2) the first rank may be determined based on an offset from the second rank (e.g., the first rank=max (1, second rank-1); and/or (3) the first rank may be determined based on the rank of the CORESET of which TCI state is determined as the default beam.

In one embodiment, a WTRU may receive a configuration of one or more codepoints for TCI state indication and each codepoint may be associated with one or more TCI states. The WTRU may receive a codepoint (e.g., based on one or more of RRC, MAC CE and DCI) for TCI state indication to transmit/receive signals and/or channels (e.g., PDSCH/PUSCH/RSs). The TCI state indication may be used to indicate one or more TCI states for multiple channels (e.g., PDSCH/PUSCH) scheduled by a single DCI.

When one TCI state is associated with the indicated codepoint, the WTRU may transmit/receive multiple signals and/or channels with the indicated TCI state. When more than one TCI state are associated with the indicated codepoint (e.g., for multi-TRP transmission) and inter-slot repetition is configured (e.g., by configuring RRC parameter repetitionNumber and tdmSchemeA), the WTRU may receive/transmit multiple PDSCHs/PUSCHs scheduled by a single DCI with inter-slot repetitions. For example, the WTRU may transmit/receive multiple PUSCHs/PDSCHs by using a TCI state for each slot based on one or combination of TCI state mapping patterns (TCI-MPs) 1, 2, or 3 in FIG. 4.

TCI-MP1, 1st TCI state and 2nd TCI sates are rotated and assigned to slots PDSCHs/PUSCHs scheduled. Further TDRA schedules first and the second reception/transmission of a PDSCH/PUSCH in the adjacent slots as shown in the figure. TCI-MP2 rotates TCI sate every two slots. However, TDRA schedules PDSCHs/PUSCHs with 1 slot gap as shown in FIG. 4. In TCI-MP3, TCI sate switching takes place from one repetition to the other and TDRA schedules all scheduled PDSCHs/PUSCHs in adjacent slots as shown in FIG. 4.

A WTRU may determine the TCI state mapping pattern for multiple channels (e.g., PDSCHs/PUSCHs) and/or signals scheduled by a single DCI based on one or more of the following embodiments as described below.

In one example, the TCI state mapping pattern may be configured by RRC signaling. For example, the WTRU may receive a configuration of one or more of TCI-MP1, TCI-MP2 and TCI-MP3 via RRC message.

In another example, the TCI state mapping pattern may be indicated by MAC-CE or DCI. For example, the WTRU may receive an indication of one or more of TCI-MP1, TCI-MP2 and TCI-MP3 via MAC CE and/or DCI.

In another example, the WTRU may determine the TCI state mapping pattern based on the TDRA. For example, each TDRA may associated with a TCI state mapping pattern.

In another example, the WTRU may determine the TCI state mapping pattern for multiple channels (e.g., PDSCHs/PUSCHs) and/or signals scheduled by a single DCI based on the number of scheduled channels (e.g., PDSCH/PUSCH) and/or signals. For example, when the number of scheduled PDSCHs is smaller, to gain additional time diversity, a WTRU may use TCI-MP3 over TCI-MP1.

In another example, the WTRU may determine the TCI state mapping pattern for multiple channels (e.g., PDSCHs/PUSCHs) and/or signals scheduled by a single DCI based on The maximum number of beam changes the WTRU may perform within a slot (maxNumberRxTxBeamSwitchDL). For example, when maxNumberRxTxBeamSwitchDL reported by the WTRU is lower than a threshold, the WTRU may use TCI-MP3 or TCI-MP2 instead of TCI-MP1 which requires 1 TCI state switching (beam switch) after each slot.

In another example, the WTRU may determine the TCI state mapping pattern for multiple channels (e.g., PDSCHs/PUSCHs) and/or signals scheduled by a single DCI based on timeDurationForQCL and scheduling offset. A WTRU may even out the impact of using default beam for the PDSCHs/PUSCHs that are received/transmitted before timeDurationForQCL by selecting a proper TCI state mapping pattern and TDRA. For example, consider the case K=4, N=2, K0 of the first PDSCH=1, and no slot level gaps are permitted between PDSCHs transmission and repetitions. If timeDurationForQCL expires in slot #4, TCI-MP3 is preferred over TCI-MP1. This is because, with TCI-MP1 two repetitions of PDSCH1 and PDSCH2 will be received with default TCI sate by the WTRU. Also, two repetitions of PDSCH3 and PDSCH4 will be received with indicated TCI sate by the WTRU. However, with TCI-MP3, one repletion of all PDSCHs scheduled will be received by the WTRU with the default TCI state and the remaining repetition will be received by the WTRU with the indicated TCI state. This may avoid performance loss due to using default QCL assumption before timeDurationForQCL heavily impacting some PDSCHs.

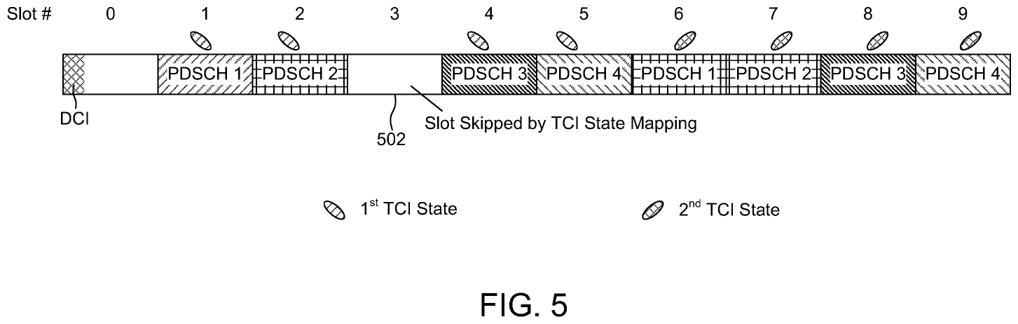

FIG. 5 is a diagram illustrating an exemplary TCI state mapping based on TDRA. If slot level gaps are configured by TDRA for multiple PDSCHs/PUSCHs scheduled, these slots are skipped by TCI state mapping pattern. For example, as shown in FIG. 5, in an instance with TCI-MP3 and the number of scheduled PDSCHs is 4 (i.e., K=4) and the number of repetitions is 2 (i.e., N=2), if TDRA configures 1 slot gap at slot 3 502, the TCI state mapping pattern also skips slot 3 502.

When a sub-slot level TDM repletion scheme is configured, a WTRU may use TCI state mapping patterns 1, 2, and 3 but with multiple PDSCHs in each slot based on the TDRA. For example, when two PDSCHs are scheduled in each slot and WTRU is configured with TCI-MP3, PDSCH1 and PDSCH2 will be received by WTRU on first subslot of slot 1 with 1st TCI sate and second subslot of slot 1 with 2nd TCI state respectively. Then the 3rd and 4th PDSCHs are scheduled in slot 2 following the same patten adapted in scheduling PDSCH1 and PDSCH2 in slot 1. This pattern continues until all the PDSCHs scheduled are assigned.

If a WTRU is scheduled with more than 2 repetitions (N>2), the WTRU may receive K PDSCHs schedule with N repetitions by repeatedly using TCI state mapping pattern 1 and TCI state mapping pattern 3.

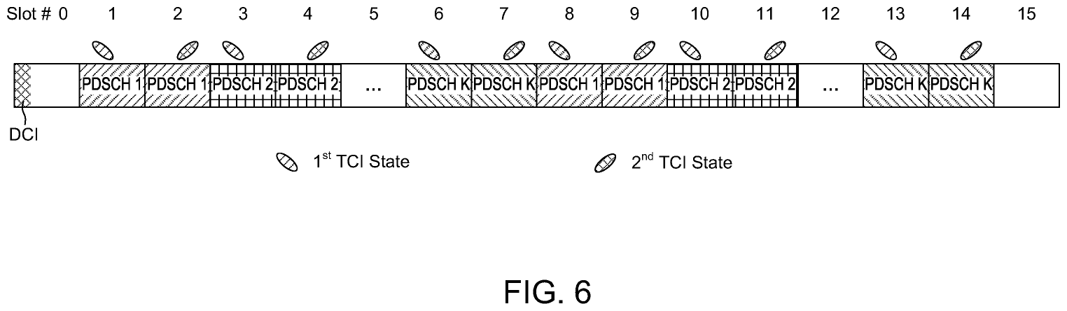

FIG. 6 is a diagram illustrating an exemplary TCI state mapping with TCI-MP1 where N>2 and is even. As shown in FIG. 6, when N=4, the same TCI state mapping pattern may be continued sequentially until the required number of repetitions are achieved.

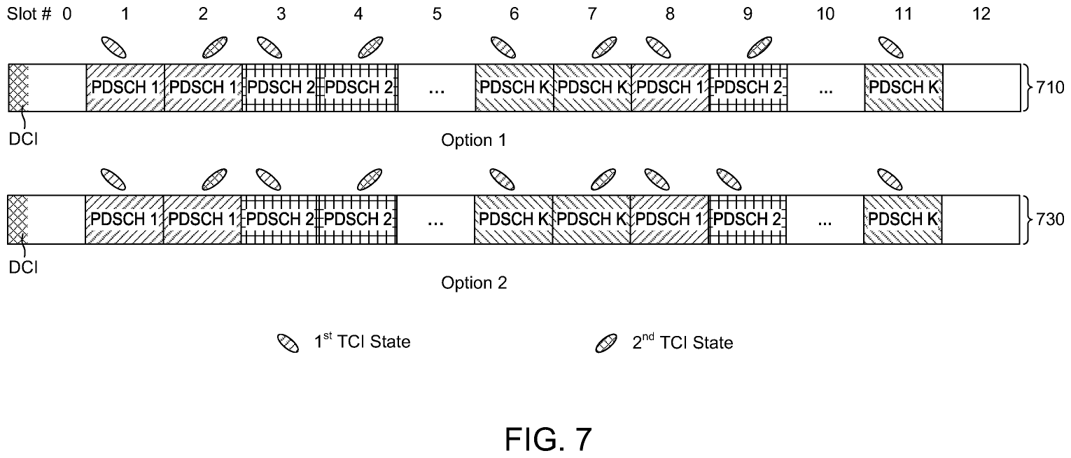

FIG. 7 is a diagram illustrating an exemplary TCI state mapping with TCI-MP1 where N>2 and is odd. As shown in FIG. 7, when N>2 and odd, first N−1 repetitions may follow the TCI state mapping pattern described in case 1 (TCI-MP1, N>2 and even). A WTRU may follow one out of following two options shown in FIG. 7 for the Nth repetition of PDSCH/PUSCHs. In option 710, the TCI sate mapping pattern is continued by altering between a 1st TCI state and a 2nd TCI sate until all the scheduled PDSCHs/PUSCHs repetitions/transmissions are assigned with a TCI sate. In Option 730, the Nth repetition of the PDSCHs/PUSCHs choose either the 1st TCI state or the 2nd TCI sate for all the PDSCHs/PUSCHs.

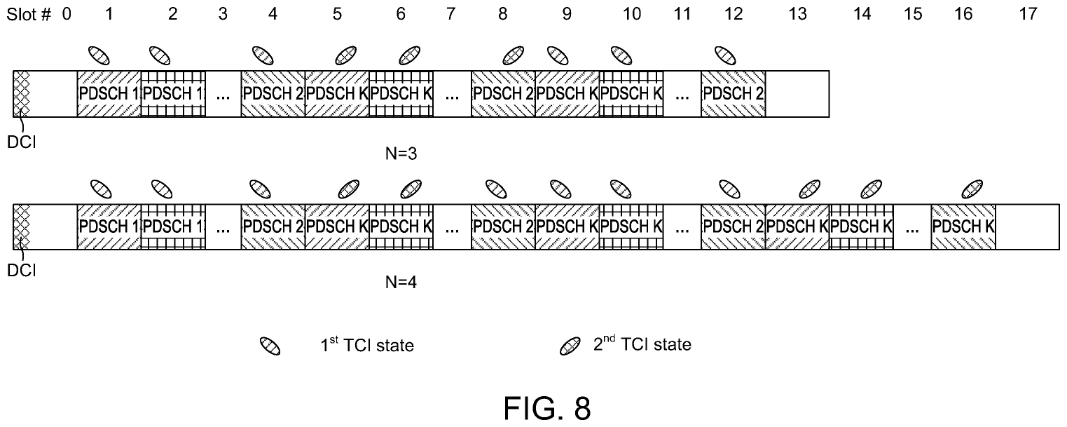

FIG. 8 is a diagram illustrating an exemplary TCI state mapping with TCI-MP3 where N>2. As shown in FIG. 8, when N>2, alternating TCI states from one repetition to the next repetition may be continued for N=3 and N=4.

A WTRU may receive/transmit multiple PDSCHs/PUSCHs scheduled by a single DCI with repetitions using TCI states for each PDSCH/PUSCH based on one of the mapping pattern and frequency hopping to gain frequency diversity.

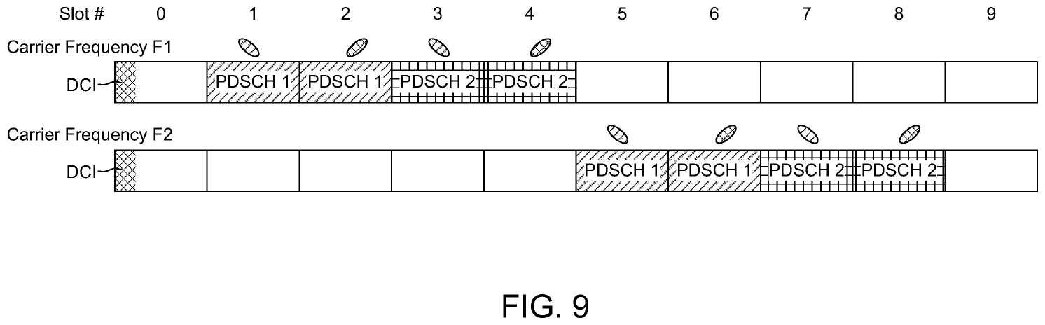

For example, FIG. 9 is a diagram illustrating an exemplary a multi PDSCH scheduling for multi-TRP transmission with repetitions and frequency hopping. As shown in FIG. 9, when K=2 and N=4, frequency hopping may be performed.

In one embodiment, a WTRU may determine time domain resource allocation for transmitting/receiving multiple channels (e.g., PUSCHs/PDSCHs) and/or signals by a single DCI with repetitions. The WTRU determination may be based on one or more of following: (1) SLIV; (2) length of each channel (e.g., PDSCH/PUSCH); and/or (3) channel (e.g., PDSCH/PUSCH) scheduling offset(e.g., K0).

If the WTRU makes the determination based on SLIV, when MCS of all the repetitions of a PDSCH is the same, the WTRU may receive an indication of only one SLIV for each PDSCH as a part of TDRA and the WTRU may determine to use the indicated SLIV to receive all the repetitions of the PDSCH. The WTRU may receive an indication of a SLIV for each repetition of a PDSCH as a part of TDRA when each repetition is configured with different MCS.

If the WTRU makes the determination based on the length of each channel, when MCS of all the repetitions of a PDSCH is the same, the WTRU may be indicated only one length value for each PDSCH as a part of TDRA and WTRU may use this length value to receive all the repetitions of the PDSCH. The WTRU may be indicated one length value per repetition of a PDSCH as a part of TDRA when each repetition is configured with different MCS.

If the WTRU makes the determination based on the channel scheduling offset, the slot level gaps may be permitted between PDSCHs. The WTRU may be indicated one K0 value for each repetition of the PDSCH as a part of TDRA. The reference slot for subsequent transmission of a PDSCH could be the slot DCI is received scheduling PDSCHs (one of the PDSCH in multi-DCI based multi-TRP case) or one of the PDSCH transmitted in the previous repetition (e.g., the last PDSCH transmitted in the previous repetition when TCI-MP3 is used). The WTRU may determine the slot PDSCH repetitions are transmitted based on the reference for K0 and the K0 indicated for each repetition as a part of TDRA.

If the WTRU makes the determination based on the channel scheduling offset, the slot level gaps may not permitted between PDSCHs. Slot level gaps are not permitted among all slots of a given repetition (1st transmission, 2nd transmission, etc.) of PDSCHs is transmitted. A WTRU may receive one K0 value per PDSCH as a part of TDRA which indicates the slot in which the first transmission of the corresponding PDSCH is scheduled. The WTRU may determine the slot subsequent transmissions of the PDSCH is scheduled based on the number of scheduled PDSCHs and the K0 indicated by TDRA.

Any of the above embodiments that are described for PDSCH transmissions are also applicable to PUSCH transmissions. Any of the above embodiments that are described for PUSCH transmissions are also applicable to PDSCH transmissions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

1. A method performed by a wireless transmit/receive unit (WTRU), the method comprising:
receiving a downlink control information (DCI), wherein the DCI includes a multi-physical downlink channel shared channel (PDSCH) priority indication;
determining a priority for each of a two or more PDSCHs transmissions based on the multi-PDSCH priority indication;
determining one or more scheduling parameters for each of the two or more PDSCH transmissions based on the determined priority of each of the two or more PDSCH transmissions; and
receiving each of the two or more PDSCH transmissions using the respective determined scheduling parameters.

2. The method of claim 1, wherein the multi-PDSCH priority indication indicates a number of high priority PDSCH transmissions, wherein the high priority PDSCHs are transmitted prior to low priority PDSCH transmissions.

3. The method of claim 1, wherein the DCI includes a bitmap that indicates the priority of each of the two or more PDSCH transmissions.

4. The method of claim 1, wherein the one or more scheduling parameters is at least one of the following: repetition number, time location, demodulation reference signal (DMRS) pattern, DMRS density, and modulation and coding scheme (MCS).

5. The method of claim 1, further comprising associating a first scheduling parameter with a first priority and a second scheduling parameter with a second priority.

6. The method of claim 5, wherein the first priority is a high priority and the second priority is a low priority.

7. A wireless transmit/receive unit (WTRU), comprising:
a transceiver; and
a processor;
wherein the transceiver and processor are configured to:
receive a downlink control information (DCI), wherein the DCI a multi-physical downlink channel shared channel (PDSCH) priority indication;
determine a priority for each of a two or more PDSCH transmissions based on the multi-PDSCH priority indication;
determine one or more scheduling parameters for each of the two or more PDSCH transmissions based on the determined priority of each of the two or more PDSCH transmissions; and
receive each of the two or more PDSCH transmissions using the respective determined scheduling parameters.

8. The WTRU of claim 7, wherein the multi-PDSCH priority indication indicates a number of high priority PDSCH transmissions, wherein the high priority PDSCH transmissions are transmitted prior to low priority PDSCH transmissions.

9. The WTRU of claim 7, wherein the DCI includes a bitmap that indicates the priority of each of the two or more PDSCH transmissions.

10. The WTRU of claim 7, wherein the one or more scheduling parameters is at least one of the following: repetition number, time location, demodulation reference signal (DMRS) pattern, DMRS density, and modulation and coding scheme (MCS).

11. The WTRU of claim 7, further comprising associating a first scheduling parameter with a first priority and a second scheduling parameter with a second priority.

12. The WTRU of claim 11, wherein the first priority is a high priority and the second priority is a low priority.

13. A method performed by a wireless transmit/receive unit (WTRU), the method comprising:
receiving a downlink control information (DCI), wherein the DCI includes a multi-physical uplink channel shared channel (PUSCH) priority indication;
determining a priority for each of a two or more PUSCH transmissions based on the multi-PUSCH priority indication;
determining one or more scheduling parameters for each of the two or more PUSCH transmissions based on the determined priority of each of the two or more PUSCH transmissions; and
transmitting each of the two or more PUSCH transmissions using the respective determined scheduling parameters.

14. The method of claim 13, wherein the multi-PUSCH priority indication indicates a number of high priority PUSCH transmissions, wherein the high priority PUSCH transmissions are transmitted prior to low priority PUSCHs.

15. The method of claim 13, wherein the DCI includes a bitmap that indicates the priority of each of the two or more PUSCH transmissions.

16. The method of claim 13, wherein the one or more scheduling parameters is at least one of the following: repetition number, time location, demodulation reference signal (DMRS) pattern, DMRS density, and modulation and coding scheme (MCS).

17. The method of claim 13, further comprising associating a first scheduling parameter with a first priority and a second scheduling parameter with a second priority.

18. The method of claim 17, wherein the first priority is a high priority and the second priority is a low priority.
